(19) United States
(12) Patent Application Publication
(10) Pub. No.: US 2003/0183793 A1
(43) Pub. Date: Oct. 2, 2003

(54) Valve for controlling liquids

(76) Inventor: Friedrich Boecking, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/221,723

(22) PCT Filed: Dec. 19, 2001
(86) PCT No.: PCT/DE01/04801

(30) Foreign Application Priority Data
Jan. 17, 2001 (DE) 1 01 01 796.0

(51) Int. Cl. F16K 31/12

(52) U.S. Cl. 251/129.06; 251/229; 251/129.2; 251/58

(57) ABSTRACT

The present invention relates to a valve for controlling fluids, which has a piezoelectric actuator (2), a mechanical booster (3) for boosting the stroke of the piezoelectric actuator (2), a restoring element (4), and an actuating piston (6). The mechanical booster (3) is disposed in the actuating direction of the piezoelectric actuator between the piezoelectric actuator (2) and the restoring element (4). Thus the mechanical booster (3) boosts the stroke of the piezoelectric actuator (2) in the actuating direction, and in the opposite direction boosts the restoring force of the restoring element (4).

### PRIOR ART

The present invention relates to a valve for controlling fluids as generically defined by the preamble to claim 1.

Valves for controlling fluids are known in various designs. Recently, the use of piezoelectric actuators has increasingly been proposed for tripping the valve. Since the piezoelectric actuators have a relatively short stroke, it has been proposed that this stroke be boosted to a greater stroke motion by means of boosters. Mechanical or hydraulic boosters can be used. If hydraulic boosters are used, it has been found that the rigidity of valves with hydraulic boosters is relatively slight, compared to those with mechanical boosters. This low stiffness adversely affects the precision of injection by the valve. In comparison to hydraulic boosters, mechanical boosters have high rigidity, but they have a relatively large number of individual parts, making their structure complicated. Moreover, because of the number of individual parts, mechanical boosters require a relatively large installation space, which is disadvantageous particularly when space is tight because of the engine compartment geometry.

### ADVANTAGES OF THE INVENTION

The valve for controlling fluids of the invention having the characteristics of claim 1 has the advantage over the prior art that it has a hydraulic booster with relatively great rigidity; the booster is disposed between the piezoelectric actuator and a restoring element. As a result, the booster acts as a mechanical booster for the piezoelectric actuator stroke in the direction of the piezoelectric actuator stroke, and in the opposite direction it acts as a force booster for the force of the restoring element. In other words, the booster is embodied such that in one direction (the stroke direction of the piezoelectric actuator) it functions as a travel booster, and in the opposite direction (the restoring direction) it acts as a force booster. Thus the spring force for restoring the piezoelectric actuator is likewise boosted by the mechanical booster, making it possible to use a spring with markedly less force and a markedly lower spring rate. As a result, the valve of the invention can be made quite compact in structure.

In a preferred exemplary embodiment, an intermediate member is disposed between the booster and the restoring element. Thus the restoring force of the restoring element is transmitted first to the intermediate member and then to the mechanical booster. As a result, geometrical simplifications in the individual parts of the booster can in particular become possible.

Preferably, the intermediate member is embodied as T-shaped in section. The protruding region of the T-shaped intermediate member can be used as a stop for the restoring element.

In a preferred feature of the present invention, the restoring element is embodied as a helical spring. If a T-shaped intermediate member is used, then in particular the cylindrical stem of the intermediate member can be introduced into the inner hollow region in the helical spring.

Preferably, the mechanical booster has rolling bodies for transmitting the stroke of the piezoelectric actuator. For instance, the rolling bodies can be embodied as rollers or balls. Especially preferably, two rolling bodies are used. The use of rolling bodies makes it possible to embody the mechanical booster especially compactly, and only slight frictional resistances occur as a result of the rolling bodies.

Preferably, the rolling bodies are actuated by means of an actuating element, which has a tapering region that is in contact with the rolling bodies. As a result, the rolling bodies can roll on the tapering region of the actuating element, and at all times only a relatively small, point-type contact region is present between the actuating element and the rolling bodies. Especially preferably, the tapering region is embodied as a cone.

In another preferred exemplary embodiment of the present invention, the rolling bodies roll on oblique faces that are embodied in a housing of the valve.

Preferably, the valve for controlling fluids of the invention is used in a common rail injection system for injecting fuel. For instance, the valve of the invention can be used in a common rail system (Diesel) or in a gasoline direct-injection system.

### DRAWING

One exemplary embodiment of the invention is shown in the drawing and will be explained in further detail in the ensuing description.

FIG. 1 is a schematic sectional view of a valve for controlling fluids of the invention, in one exemplary embodiment of the present invention.

### DESCRIPTION OF THE EXEMPLARY EMBODIMENT

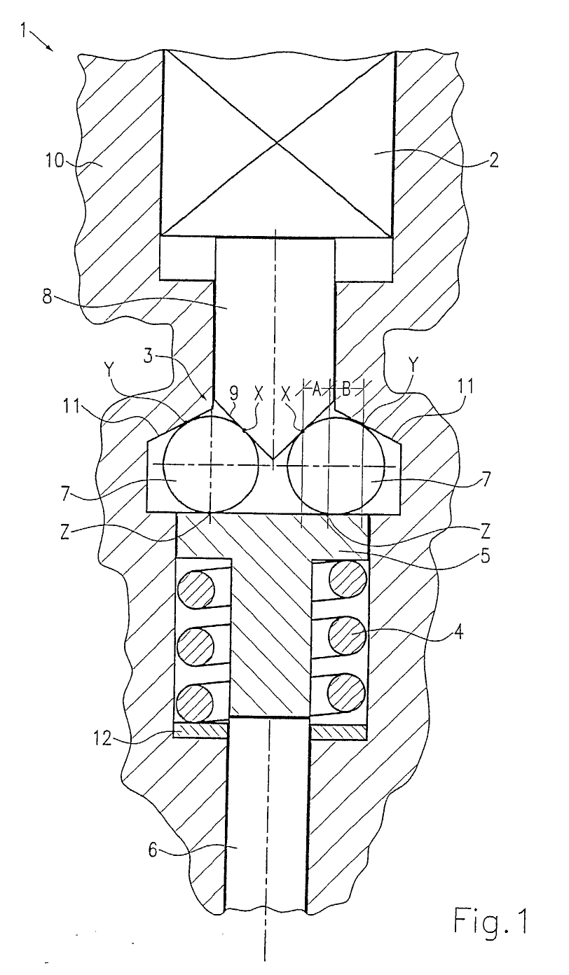

In FIG. 1, a valve 1 for controlling fluids in accordance with one exemplary embodiment of the present invention is shown. The valve 1 shown in FIG. 1 is a control valve for a fuel injection valve.

As shown in FIG. 1, the valve 1 includes a piezoelectric actuator 2, a mechanical booster 3, and a restoring element 4. The mechanical booster 3 has two rollers 7, which can roll on an oblique or inclined face 11 that is formed in a housing 10 of the valve 1. The piezoelectric actuator 2 is in contact with the mechanical booster 3 via an actuating element 8. On its end toward the mechanical booster 3, the actuating element 8 has a conically tapering region 9.

In addition, an intermediate member 5 is disposed between the mechanical booster 3 and the restoring element 4; it is embodied as T-shaped in section. As a result, the intermediate member 5 can receive the restoring element 4, embodied as a helical spring, and thus serves as a spring seat for the helical spring 4. As shown in FIG. 1, the helical spring 4 and the intermediate member 5 are disposed in a stepped bore provided in the housing 10 of the valve 1; a shim 12 is disposed in the bore, and the helical spring 4 is supported on this shim. As a result, damage to the housing from the housing from the compressive force of the helical spring 4 can be averted.

As shown in FIG. 1, the intermediate member 5 of T-shaped section is in contact with an actuating piston 6, which in turn, in a known manner, for instance via a control chamber, actuates the injector of a fuel injection valve (not shown).

The function of the valve 1 of the invention is as follows:

When the piezoelectric actuator 2 is activated, an increase in its length occurs in the direction of the mechanical booster 3. This piezoelectric actuator stroke is transmitted to the actuating element 8, which has the tapering region 9. The actuating element 8 is in contact with the two rolling bodies 7 at points X in this tapering region 9. Moreover, the two rolling bodies 7 each form point-type connecting points Y, Z with the oblique faces 11 of the housing 10 and with the intermediate member 5. More precisely, the rolling bodies 7 are in contact with the housing 10 at points Y and with the intermediate member 5 at points Z.

Thus the stroke of the piezoelectric actuator 2 is transmitted via the actuating element 8 to the rolling bodies 7, which are pressed outward by the tapering region 9 of the actuating element 8. As a result of the oblique faces 11 on the housing 10, this outward-oriented motion is partially converted into a downward-oriented motion of the rolling bodies 7. As a result, the two rolling bodies 7 press on the intermediate member 5, which thus actuates the actuating piston 6. At the same time, the helical spring 4 is compressed by the intermediate member 5. As a result, in a known manner, a valve needle on the injector can open and a fuel injection can ensue. Thus the relatively short stroke of the piezoelectric actuator 2 has been boosted by the mechanical booster, with a boosting ratio of A:B (see FIG. 1).

When the piezoelectric actuator 2 is deactivated, the piezoelectric actuator 2 shortens again, so that by means of the restoring force of the helical spring, both the mechanical booster 3 and the actuating element 8 are returned to their outset position. The restoring force of the helical spring 4 is stepped back via the mechanical booster 3 in the proportion B:A, and as a result there is a boost in the restoring force. Because of this force boost, it is possible for the restoring element 4 to be embodied as smaller than in the prior art. Thus the usually required high prestressing force of 800 to 1000 N for the prestressing of the piezoelectric actuator 2 can be achieved by the mechanical booster 3 with a spring 4 with a lower spring rate. The spring rate of the helical spring 4 should be selected in accordance with the force boosting ratios B:A. Thus the mechanical booster 3 furnishes a travel boost in the piezoelectric actuator stroke in the stroke direction of the piezoelectric actuator 2, and in the opposite direction, that is, the restoring direction of the valve, it furnishes a force boost of the force of the helical spring 4. Thus an especially compact valve, in particular a control valve for fuel injection valves, can be obtained.

Accordingly, the present invention relates to a valve for controlling fluids which a piezoelectric actuator 2, a mechanical booster 3 for boosting the stroke of the piezoelectric actuator 2, a restoring element 4, and an actuating piston 6 for actuating a valve member. The mechanical booster 3 is disposed between the piezoelectric actuator 2 and the restoring element 4 in the actuating direction of the piezoelectric actuator. Thus the mechanical booster 3 in the actuating direction boosts the piezoelectric actuator stroke, and in the opposite direction it boosts the restoring force of the restoring element 4.

The above description of the exemplary embodiment of the present invention is intended solely for illustrative purposes and not for the sake of limiting the invention. Within the scope of the invention, various changes and modifications are possible without departing from the scope of the invention or its equivalents.

1. A valve for controlling fluids, having a piezoelectric actuator (2), a mechanical booster (3) for boosting the stroke of the piezoelectric actuator (2), a restoring element (4), and an actuating piston (6), characterized in that the mechanical booster (3) is disposed in the actuating direction of the piezoelectric actuator between the piezoelectric actuator (2) and the restoring element (4), so that the booster (3) boosts the stroke of the piezoelectric actuator (2) in the actuating direction, and in the opposite direction boosts the restoring force of the restoring element (4).

2. The valve for controlling fluids of claim 1, characterized in that an intermediate member is disposed between the booster (3) and the restoring element (4).

3. The valve for controlling fluids of claim 2, characterized in that the intermediate member (5) is embodied as T-shaped in section.

4. The valve for controlling fluids of one of claims 1-3, characterized in that the restoring element (4) is embodied as a helical spring.

5. The valve for controlling fluids of one of claims 1-4, characterized in that the mechanical booster (3) has rolling bodies (7) for transmitting the stroke of the piezoelectric actuator (2).

6. The valve for controlling fluids of claim 5, characterized in that the rolling bodies (7) are actuated by means of an actuating element (8).

7. The valve for controlling fluids of claim 6, characterized in that the actuating element (8) has a tapering region (9).

8. The valve for controlling fluids of claim 7, characterized in that the tapering region (9) is embodied as a cone.

9. The valve for controlling fluids of one of claims 5-8, characterized in that the rolling bodies (7) roll on oblique faces (11) that are embodied in a housing (10) of the valve.

10. The use of a valve for controlling fluids of one of the foregoing claims in a common rail injection system.
